(19) United States
(12) Patent Application Publication
(10) Pub. No.: US 2021/0252320 A1
(43) Pub. Date: Aug. 19, 2021

(54) SUSPENSION AND CONTROL HEAD APPARATUS FOR AERIAL FIREFIGHTING BUCKET

(71) Applicant: DONMARK HOLDINGS INC., Delta (CA)

(72) Inventors: Donald ARNEY, Delta (CA); Peter BROOKE, Delta (CA)

(21) Appl. No.: 17/164,522

(22) Filed: Feb. 1, 2021

Related U.S. Application Data
(60) Provisional application No. 62/970,120, filed on Feb. 4, 2020.

(51) Int. Cl. A62C 3/02; B64D 1/16; B64D 9/00

(52) U.S. Cl. CPC A62C 3/0235; B64D 9/00; B64D 1/16

(57) ABSTRACT

A suspension and control head apparatus for an aerial firefighting bucket that is suspendable from an aircraft and operable to release fluid by a movable valve, the apparatus comprising an elongate rigid spreader having attachment portions at opposite ends of the spreader member; a housing connected to the spreader member between the attachment portions; a remotely controllable actuator within the housing operable to advance and retract a valve control line connected to the movable valve on the bucket to open and close the valve; a cargo ring adapted to connecting to a cargo hook on the aircraft; suspension lines connected between each attachment portion and the cargo ring; and the ends of the spreader bar being operable to connect to bucket support lines for suspending the weight of the firefighting bucket evenly between the ends.

### FIELD OF THE INVENTION

The invention relates to aerial firefighting buckets and to improved suspension and control head apparatus for aerial firefighting buckets.

### BACKGROUND OF THE INVENTION

Aerial firefighting buckets, particularly those for carrying by helicopter or other hover capable aircraft, are well known. Some examples of aerial firefighting buckets in the prior art are disclosed in U.S. Pat. Nos. 4,474,245; 4,576,237; 5,560,429; 7,708,082; and 8,453,753. These patents disclose helicopter carried firefighting buckets that, at their simplest, comprise a rigid or flexible reservoir for holding a volume of water, a sling to suspend the reservoir from a helicopter, a valve, and an actuator which is controlled from inside the helicopter to operate the valve to release the water from the reservoir over the fire. In FIG. 1 there is shown an example of a prior art aerial firefighting bucket system shown generally as 10. The system 10 includes a bucket 12 for containing a volume of fluid. The bucket 12 includes a bottom interior surface having a valve 18 thereon for controllably releasing a stream 24 of the fluid over a fire, for example. The bucket 12 is suspended from a control head 26 by support cables 15 and the control head 26 is connected to the cargo hook 20 of helicopter 22. A control cable 16 runs between the helicopter 22 and the control head 26 to transmit instructions from an operator to the control head 26. The control cable 16 may be an electrical cable, a hydraulic hose, or a pneumatic hose, for example. An actuator cable 28 may be connected between the control head 26 and the valve 18 to enable the control head 26 to open and close the valve 18 in response to operator commands. Various actuator mechanisms of the control head 26 are known in the prior art, including some described in the patents mentioned above herein.

A problem with some control heads such as control head 26 of the prior art is that they may be too tall, particularly on helicopters with low skid gear. When landing, there is a danger of the helicopter landing on top of a control head that settles on the ground in an upright vertical orientation, which could cause an upward force into the cargo hook potentially damaging the cargo hook and the belly of the helicopter. Another problem with some control heads of the prior art is that the suspension lines often twist during filling and do not untwist once the bucket is in the air again. This could result in fowling of the trip line or actuator cable to the valve. The cause is attributable to the bucket support cable attachment points on each side of the control head not being far enough apart. Furthermore, some of the control heads of the prior art are too heavy because they are robustly constructed to be able to support the full weight of a bucket filled with fluid.

### SUMMARY OF THE INVENTION

The present invention addresses the difficulties and disadvantages of the prior art by providing a suspension and control head apparatus for an aerial firefighting bucket that is suspendable from an aircraft and operable to release fluid by a movable valve, the suspension and control head apparatus comprising: an elongate rigid spreader member having a first end with a first attachment portion and an opposite second end with a second attachment portion that is remote from the first attachment portion; a housing connected to the spreader member between the first attachment portion and the second attachment portion; a remotely controllable actuator within the housing operable to advance and retract a valve control line connected to the movable valve on the bucket to open and close the valve; a cargo ring adapted to connecting to a suspension apparatus on the aircraft; a first suspension line connected between the first attachment portion and the cargo ring, and second suspension line connected between the second attachment portion and the cargo ring; and the first end and the second end of the spreader bar being operable to connect to bucket support lines for suspending the weight of the firefighting bucket evenly between the first end and the second end.

In some embodiments, the apparatus further comprises a third suspension line connected between the first attachment portion and the cargo ring, and fourth suspension line connected between the second attachment portion and the cargo ring.

In some embodiments, the apparatus further comprises an orientation line extending between the cargo ring and one of the first end or second end of the spreader member and operable to orient the spreader member to be perpendicular to the cargo ring.

In some embodiments, the housing defines a compartment having an open end and further includes a mounting plate removably received in the compartment, and the actuator is mounted onto the mounting plate. In some embodiments, the housing further includes a cover along a lower edge of the mounting plate that is configured to substantially close the open end in the housing when the mounting plate is received within the compartment of the housing but leaving sufficient access for communication between the actuator and the valve control line.

In some embodiments, the first attachment portion and the second attachment portion each comprise an attachment bracket secured to an end of the spreader member, and each attachment bracket includes a suspension line attachment point located above the spreader member for receiving the suspension lines, and a support line attachment point located beneath the spreader member for receiving bucket support lines.

In some embodiments, the apparatus further comprises an orientation line extending between the cargo ring and the suspension line attachment point of the attachment bracket at one of the first end or second end of the spreader member and operable to orient the spreader member to be perpendicular to the cargo ring.

In some embodiments, the apparatus further comprises a plurality of bucket support lines, each extending from one of the first end or second end of the spreader member to an attachment point on the bucket.

A detailed disclosure following, related to drawings, describes a preferred embodiment of the invention which however is capable of expression in structure other than that particularly described and illustrated.

### DESCRIPTION OF THE DRAWINGS

In drawings which illustrate by way of example only embodiments of the invention:

FIG. 1 is a front elevation of an aerial fire-fighting bucket system of the prior art;

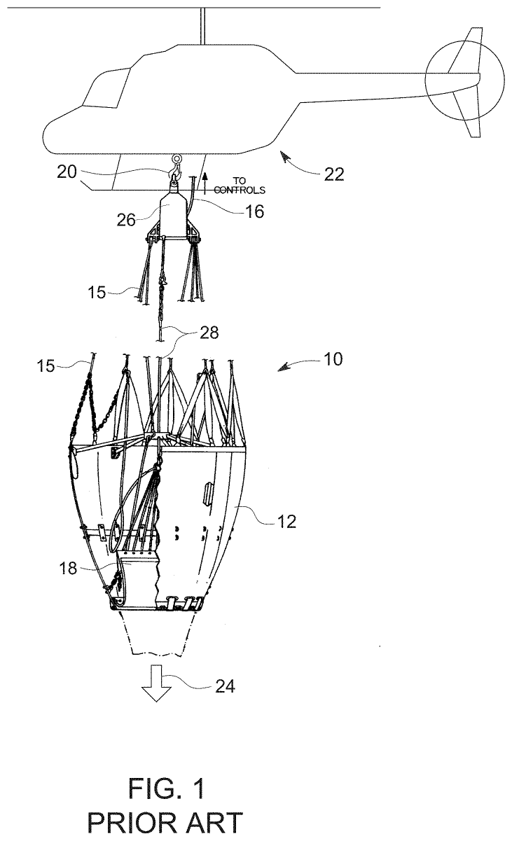

FIG. 2 is a front elevation of an aerial fire-fighting bucket system having a suspension and control head according to one aspect of the invention;

FIG. 3 is a front elevation view of an embodiment of a suspension and control head apparatus,

FIG. 4 is a perspective view of the suspension and control head apparatus of FIG. 3;

FIG. 5 is a top plan view of the suspension and control head apparatus of FIG. 3;

FIG. 6 is a front elevation view of the suspension and control head apparatus of FIG. 3 shown in an alternate configuration;

FIG. 7 is a perspective view of the suspension and control head apparatus of FIG. 6;

FIG. 8 is a side elevation view of the suspension and control head apparatus of FIG. 6;

FIG. 9 is a top plan view of the suspension and control head apparatus of FIG. 6;

FIG. 10 is a front elevation view of another embodiment of a suspension and control head apparatus;

FIG. 11 is a perspective view of the suspension and control head apparatus of FIG. 10;

FIG. 12 is a perspective view of the suspension and control head apparatus of FIG. 10 shown in an alternate configuration;

FIG. 13 is a close-up perspective view of the cargo ring portion of the suspension and control head apparatus of FIG. 12;

FIG. 14 is a top plan view of the suspension and control head apparatus of FIG. 12; and

FIG. 15 is a perspective view of the housing and the internal actuator mechanism of the suspension and control head apparatus of FIGS. 3 and 10.

### DETAILED DESCRIPTION

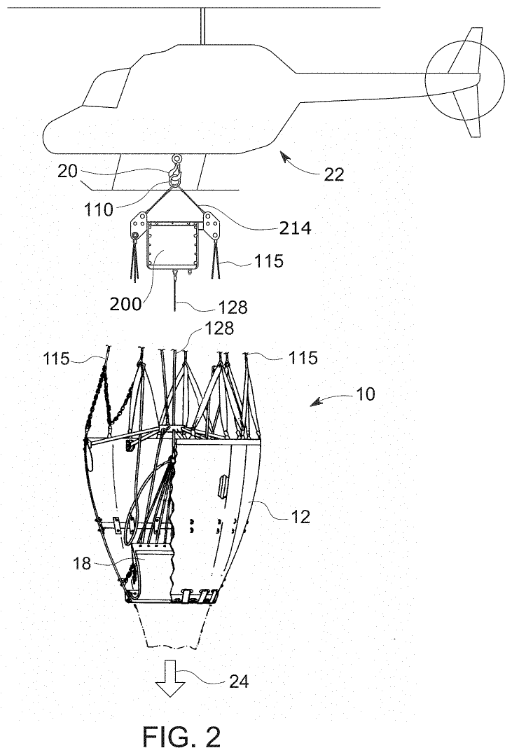

Referring to FIG. 2, there is shown an aerial fire-fighting bucket system having a suspension and control head apparatus 200, or simply referred to herein as a control head, according to one aspect of the invention. The aerial firefighting bucket system includes a bucket 12 for containing a volume of fluid. The bucket 12 includes a bottom interior surface having a valve 18 thereon for controllably releasing a stream 24 of the fluid over a fire, for example. The bucket 12 is suspended from the control head 200 by bucket support cables 115 and the control head 100 is suspended from cargo hook 20 of helicopter 22 by cargo ring 110 that is connected to suspension lines such as support cables 214. A valve control line such as control cable 128 is connected between an actuator mechanism in the control head 100 and the valve 18 to enable the control head 100 to open and close the valve 18 in response to operator commands. A communication cable 116 runs between the helicopter 22 and the control head 100 to transmit instructions from an operator to the control head 100. The communication cable 116 is an electrical cable in the illustrated embodiment but it could be a hydraulic hose or a pneumatic hose, for example, depending on the manner operation of the actuator mechanism. For example, communication cable 116 carries helicopter power to a solenoid in the actuator mechanism to actuate the control cable 128. Power comes from a control switch generally mounted on the cyclic control in the helicopter which is pressed to open the valve and dump the bucket.

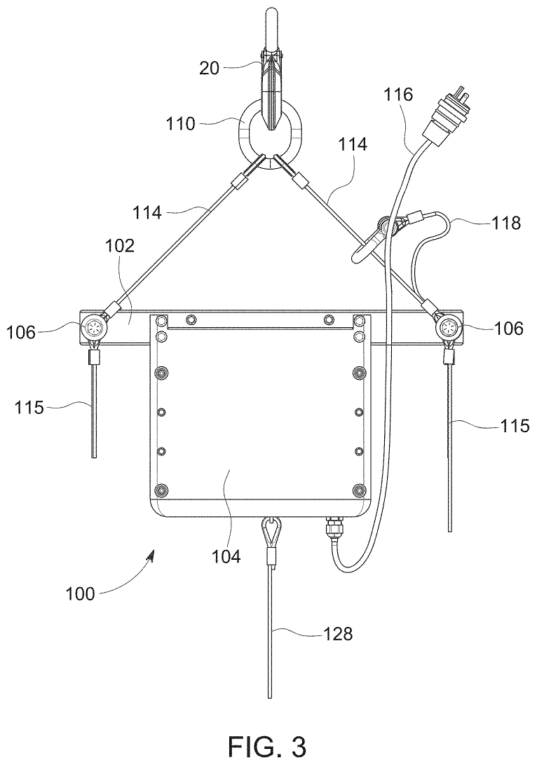

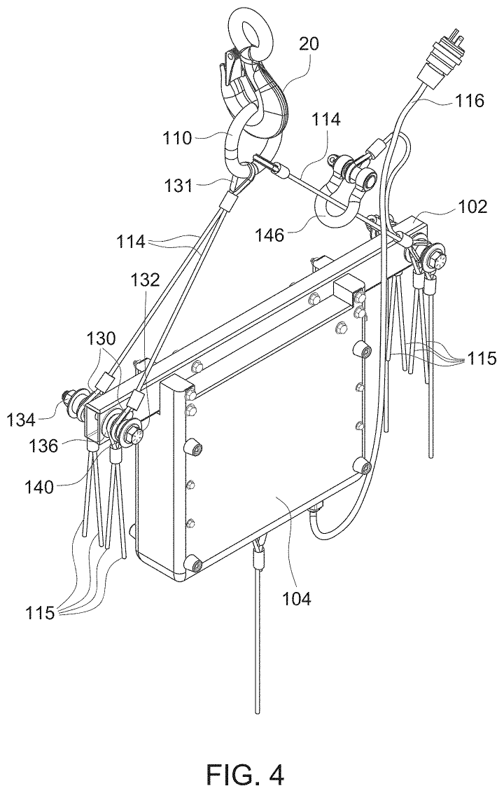

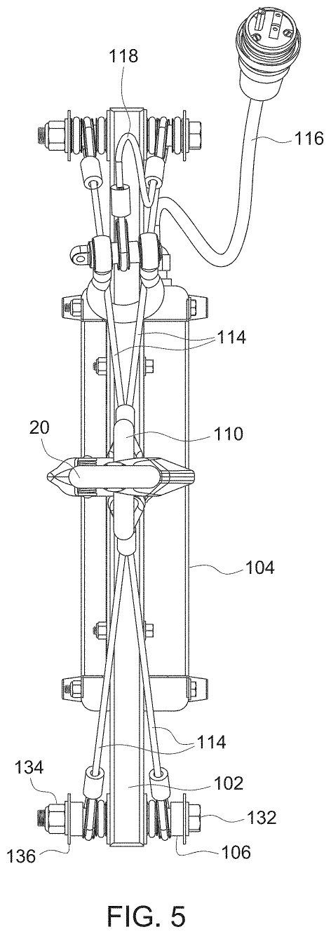

Referring to FIGS. 3-5, a suspension and control head apparatus 100 is shown in detail. Control head 100 comprises an elongate rigid spreader member such as spreader bar 102 to which is connected a housing 104 for the actuator mechanism (not shown) that is responsible for moving control cable 128. The spreader bar 102 defines opposite first and second ends, each of which includes a cable attachment point or portion 106. Support cables 114 extend between the cargo ring 110 and each of the cable attachment points 106 at each end of the spreader bar 102. The housing 104 is connected to the spreader bar 102 between the attachment points 106 at a location approximately in the middle of the spreader bar such as to be suspended from the spreader bar. The actuator mechanism (not shown) is provided in the housing and is operable to advance and retract the valve control cable 128 that is connected to the movable valve 18 on the bucket 12 to open and close the valve. An orientation cable 118 is shown that operates to alter the orientation of the spreader bar to the cargo ring as will be explained below herein. The orientation cable 118 is shown connected at one end to one of the attachment points 106 but is otherwise loosely connected to an adjacent support cable 114 such that there is no tension in the orientation cable 118. The cable attachment points 106 also serve as the attachment points for the bucket support cables 115 which extend down to various attachment points on the bucket to suspend the bucket below the control head 100.

In the embodiment as illustrated, the suspension cables 114 comprise a cable having end loops 130 at each end and an intermediate loop 131 located at the middle of the cable to be equidistant from each of the end loops 130. The cable attachment points 106 comprise a bolt 132 extending through an end of the spreader bar 102 and on which a nut 134 is secured. The end loops 130 of each suspension cable 114 is threaded onto the bolt 132, one on either side of the spreader bar 102, and then secured by the nut 134. The intermediate loop 131 of each suspension cable 114 is threaded onto the cargo ring 110, which may be a ring that can be opened and closed, or the loops 131 may be permanently fixed onto the cargo ring 110 at the time of manufacture. The support cables 115 may likewise have an end loop 140 that is also threaded onto the bolt 132 of the attachment point 106. Washers 136 are provided to separate the end loops 130 of each suspension cable 114 from the loops 140 of the support cables 115. In the embodiment is illustrated, there are two suspension cables 114 wherein one suspension cable connects one cable attachment point 106 to the cargo ring 110 and the other suspension cable connects the other cable attachment point 106 on the other side of the spreader bar to the cargo ring 110.

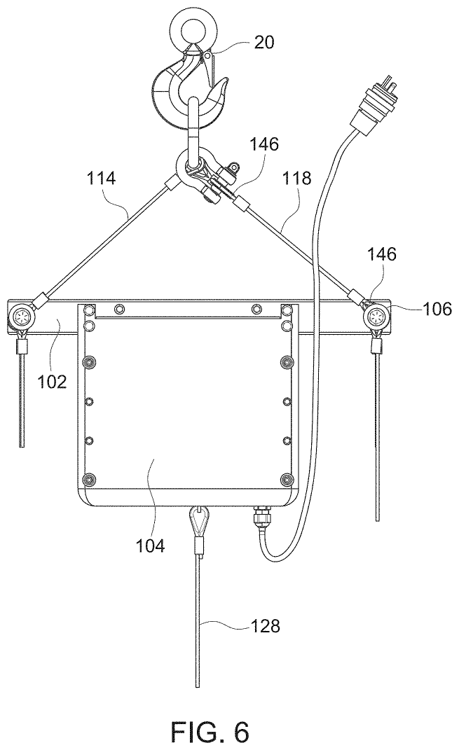

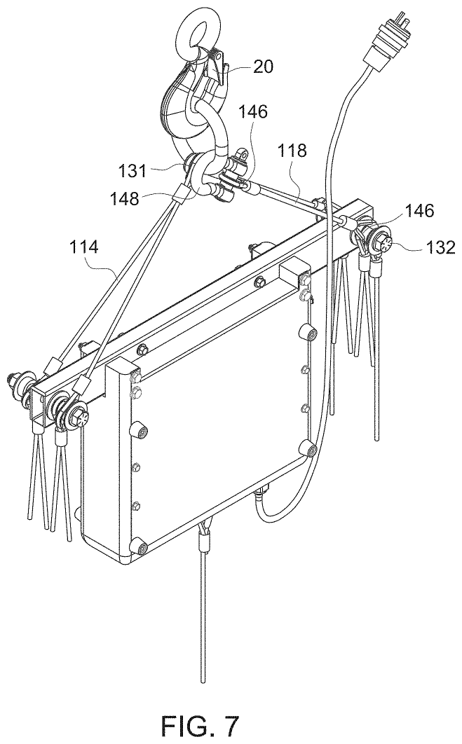

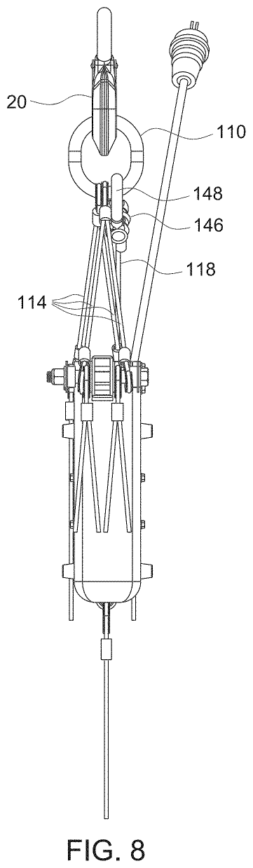

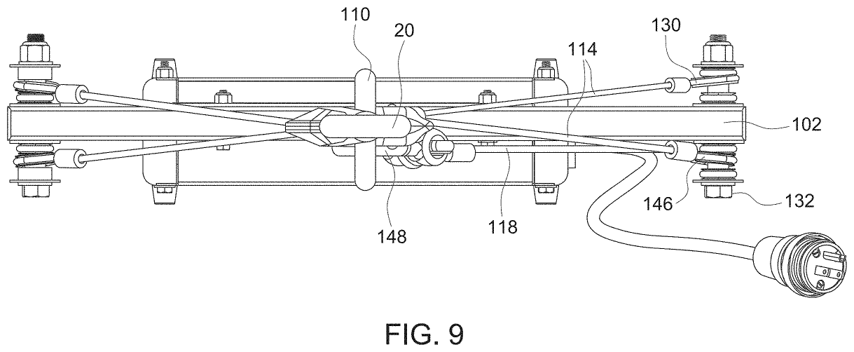

In the configuration of the embodiment illustrated in FIGS. 3-5, the plane of the spreader bar 102 is roughly perpendicular to the plane of the cargo hook 20. However, in certain aircraft configurations or applications, it may be desirable to orient the plane of the spreader bar 102 to be roughly parallel with the plane of the cargo hook 20. In those situations, the orientation cable 118 may be used as a secondary connection between one of the attachment points 106 and the cargo hook 110 as illustrated in FIGS. 6-9.

As shown in FIG. 6-9, the orientation cable 118 comprises a cable having end loops 146, one of which is threaded onto the nut 132 of an attachment point 106 and the other of which is threaded onto shackle 148. The shackle 148 is connected onto the cargo ring 110 on one side of the intermediate loops 131 of the suspension cables 114 so that when the orientation cable 118 is taut it pulls the spreader bar 102 into an orientation that is perpendicular to the cargo ring 110 and thus parallel with the cargo hook 20.

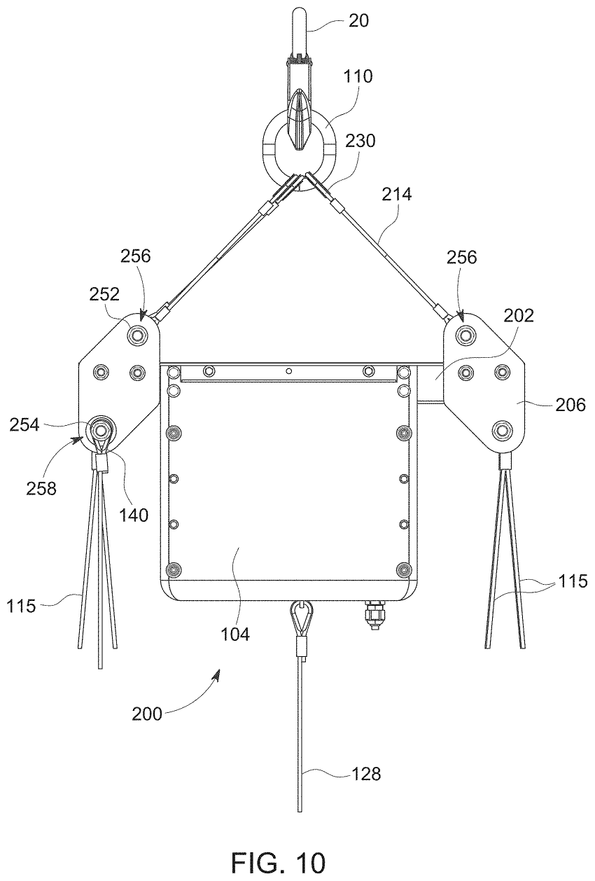

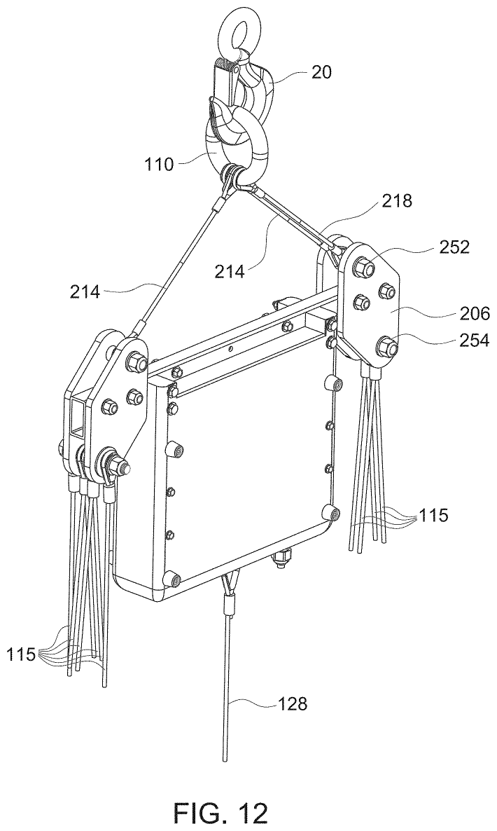

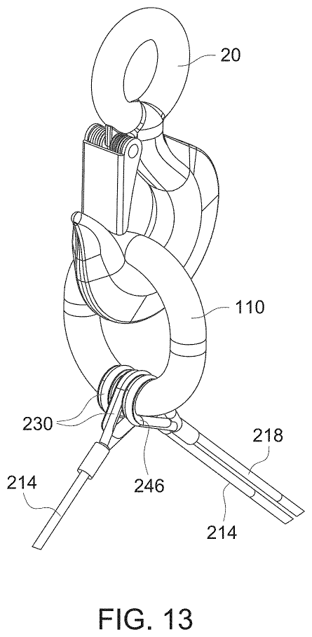

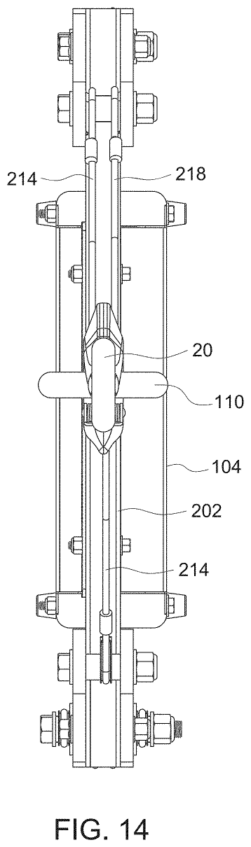

Referring to FIGS. 10-14, another embodiment of a suspension and control head apparatus in accordance with the present invention is shown at 200. Control head 200 comprises an elongate rigid spreader member such as spreader bar 202 to which is connected housing 104 for the actuator mechanism (not shown) that is responsible for moving control cable 128. The spreader bar 202 defines opposite first and second ends, each of which includes a cable attachment point or attachment bracket 206. Suspension cables 214 extend between the cargo ring 110 and each of the cable attachment brackets 206 at each end of the spreader bar 202. The housing 104 is connected to the spreader bar 202 between the attachment brackets 206 at a location approximately the middle of the spreader bar to be suspended from the spreader bar. The actuator mechanism (not shown) is provided in the housing and is operable to advance and retract the valve control cable 128 that is connected to the movable valve 18 on the bucket 12 to open and close the valve. An orientation cable 218 is shown (FIGS. 12-14) that operates to alter the orientation of the spreader bar to the cargo ring as will be explained below herein. The cable attachment brackets 206 also serve as the attachment points for the bucket support cables 115 which extend down to various attachment points on the bucket to suspend the bucket below the control head 200.

In the embodiment as illustrated in FIGS. 10-14, the suspension cables 214 comprise a cable having end loops 230 at each end. Each cable attachment bracket 206 comprises parallel plates 250 mounted to each end of the spreader bar 202 with each plate 250 being on an opposite side of the spreader bar then the adjacent plate 250 of the same attachment bracket 206. The plates 250 of each attachment bracket 206 are also connected to each other at an upper portion with bolt 252 and a lower portion with bolt 254. The bolt 252 provides a suspension cable attachment point 256 on the attachment bracket 206 for the suspension cables 214, and the bolt 254 provides a support cable attachment point 258 on the attachment bracket 206 for the support cables 115.

The end loops 230 at one end of each suspension cable 214 is threaded onto the bolt 252 and loop 230 of the other end is connected onto the cargo ring 110, which may be a ring that can be opened and closed, or the loops 230 may be permanently fixed onto the cargo ring 110 at the time of manufacture. The support cables 115 may likewise have an end loop 140 that are threaded onto the bolt 254 of the attachment brackets 206. In the embodiment is illustrated, there are two suspension cables 214 wherein one suspension cable connects one attachment bracket 206 to the cargo ring 110 and the other suspension cable 214 connects the other attachment bracket 206 on the other side of the spreader bar to the cargo ring 110.

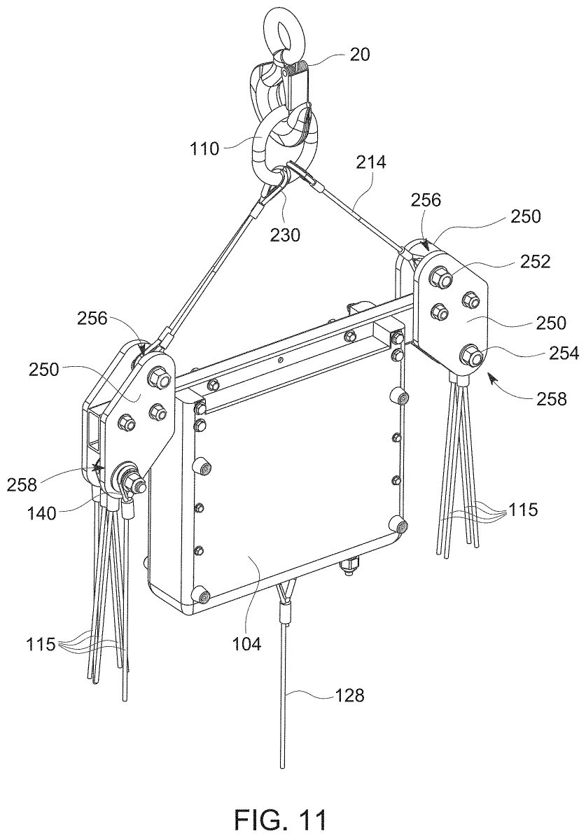

In the configuration of the embodiment illustrated in FIGS. 10-11, the plane of the spreader bar 202 is roughly perpendicular to the plane of the cargo hook 20. However, in certain aircraft configurations or applications, it may be desirable to orient the plane of the spreader bar 202 to be roughly parallel with the plane of the cargo hook 20. In those situations, the orientation cable 218 may be used as a secondary connection between one of the attachment brackets 206 and the cargo ring 110 as illustrated in FIGS. 12-14.

As shown in FIG. 12-14, the orientation cable 218 is in the form of another suspension cable 214 having end loops 246 at each end, one of which is threaded onto the bolt 252 of an attachment bracket 206 and the other of which is threaded onto the cargo ring 110 so that its end loop 246 is to one side of the end loops 230 of the other suspension cables to 14 so that when the orientation cable 218 is taut it pulls the spreader bar 202 into an orientation that is perpendicular to the cargo ring 110 and thus parallel with the cargo hook 20.

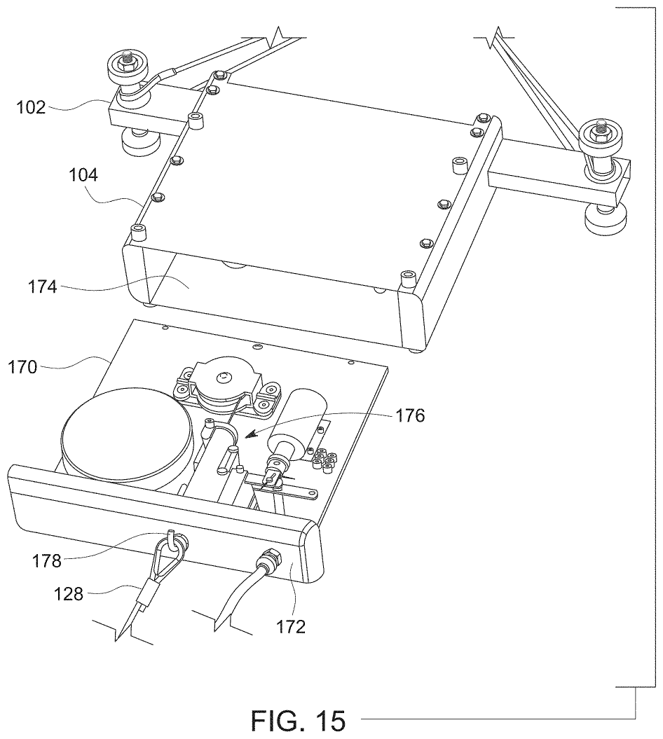

Referring to FIG. 15, there shown in perspective view of the housing 104 and the internal actuator mechanism 176 that is operable to advance and retract the valve control cable 128 that is connected to the movable valve 18 on the bucket 12 to open and close the valve. Actuator mechanisms 176 are known in the prior art and are not described herein in detail. Rather the unique mounting of the actuator mechanism 176 within housing 104 is described in more detail. Housing 104 defines a hollow compartment, rectangular in the illustrated embodiments, that is adapted to receive a complementarily shaped mounting plate 170 onto which the components of the actuator mechanism 176 are mounted. A cover 172 is provided along the lower edge of the mounting plate 170 that is configured to close the opening 174 in the housing 104 when the mounting plate 170 is received within the housing 104. The cover includes an opening 178 on the face thereof through which the control cable 128 or its actuating mechanisms pass. Aircraft bolts with nylon lock nuts or other fasteners (not shown) may be used to secure the cover 172 onto the housing 104 and/or to secure the mounting plate 170 within the housing 104. Hence the housing comprises a protective box that encloses the inner workings of the head (the actuator mechanism). This box does not sustain any bucket weight forces. And the mounting plate and cover provide a sliding drawer arrangement such that the plate with the actuator mechanism components slides in and out of the protective box. The sliding drawer makes access much simpler for control head servicing. The mounting plate preferably slides in longitudinal slots is provided on the inside of the sidewalls of the housing. Preferably the communication cable 116 enters the housing 104 through the bottom 172, which makes extraction of the drawer tray easier than if it was routed through vertical sidewall of the housing.

The advantage of the above configuration is that the actuator mechanism 176 is easily accessible for repair or replacement by simply removing the mounting plate 170 from the housing 104. Since the weight of the bucket 12 and its fluid content is supported by the spreader bar, the housing 104 on the control head may thus be manufactured of lighter material since it does not bear significant weight. This is in contrast to some of the prior art control heads that bear all of the weight of the bucket 12 and its fluid content, and are therefore required to be made of structurally robust material and are consequently heavier and more difficult to dismantle for the purposes of reaching the internal actuator mechanism. The simplified structure of the housing and the mounting of the actuator mechanism components onto a mounting plate result in a significant weight reduction over the prior art control heads and provide for easy access to and simplified repair of the internal actuator mechanism components.

An advantage of the suspension and control head apparatus of the present invention is that the bucket support line attachment points are significantly further apart which provides a significant improvement in preventing the twisting of the lines to address one of the deficiencies in some control heads of the prior art. Preferably the length of the spreader bar of the present invention is proportional to the size and weight of the bucket, and is sized to create the maximum resistance to twisting for a particular size of bucket.

Another advantage of the suspension and control head apparatus of the present invention is its reduced weight over control heads of the prior art. With the prior art control heads, all the weight of the bucket and its load was supported by the frame of the head, which required heavy and robust materials. With the novel control head of the present invention, the support cables from the bucket attach to either end of a spreader bar. The suspension cables from the cargo ring that attaches to the cargo hook of the helicopter also attach to either end of the spreader bar. Accordingly, the weight of the bucket and water is not imparted into the control head of the present invention other than the compression forces applied to the spreader bar. This reduces the weight of the new head.

It is understood that the embodiments described and illustrated herein are merely illustrative of embodiments of the present invention. Other embodiments that would occur to those skilled in the art are contemplated within the scope of the present invention. The invention includes variants not described or illustrated herein in detail. Thus, the embodiments described and illustrated herein should not be considered to limit the invention as construed in accordance with the accompanying claims.

What is claimed is:

1. A suspension and control head apparatus for an aerial firefighting bucket that is suspendable from an aircraft and operable to release fluid by a movable valve, the suspension and control head apparatus comprising:
a. an elongate rigid spreader member having a first end with a first attachment portion and an opposite second end with a second attachment portion that is remote from the first attachment portion;
b. a housing connected to the spreader member between the first attachment portion and the second attachment portion;
c. a remotely controllable actuator within the housing operable to advance and retract a valve control line connected to the movable valve on the bucket to open and close the valve;
d. a cargo ring adapted to connecting to a suspension apparatus on the aircraft;
e. a first suspension line connected between the first attachment portion and the cargo ring, and second suspension line connected between the second attachment portion and the cargo ring; and
f. the first end and the second end of the spreader bar being operable to connect to bucket support lines for suspending the weight of the firefighting bucket evenly between the first end and the second end.

2. The apparatus as claimed in claim 1 further comprising a third suspension line connected between the first attachment portion and the cargo ring, and fourth suspension line connected between the second attachment portion and the cargo ring.

3. The apparatus as claimed in any one of claims 1 and 2, further comprising an orientation line extending between the cargo ring and one of the first end or second end of the spreader member and operable to orient the spreader member to be perpendicular to the cargo ring.

4. The apparatus as claimed in claim 1 wherein the housing defines a compartment having an open end and further includes a mounting plate removably received in the compartment, and the actuator is mounted onto the mounting plate.

5. The apparatus as claimed in claim 4 wherein the housing further includes a cover along a lower edge of the mounting plate that is configured to substantially close the open end in the housing when the mounting plate is received within the compartment of the housing but leaving sufficient access for communication between the actuator and the valve control line.

6. The apparatus as claimed in claim 1 wherein the first attachment portion and the second attachment portion each comprise an attachment bracket secured to an end of the spreader member, and each attachment bracket includes a suspension line attachment point located above the spreader member for receiving the suspension lines, and a support line attachment point located beneath the spreader member for receiving bucket support lines.

7. The apparatus as claimed in claim 6, further comprising an orientation line extending between the cargo ring and the suspension line attachment point of the attachment bracket at one of the first end or second end of the spreader member and operable to orient the spreader member to be perpendicular to the cargo ring.

8. The apparatus as claimed in claim 6 wherein the housing defines a compartment having an open end and further includes a mounting plate removably received in the compartment, and the actuator is mounted onto the mounting plate.

9. The apparatus as claimed in claim 8 wherein the housing further includes a cover along a lower edge of the mounting plate that is configured to substantially close the open end in the housing when the mounting plate is received within the compartment of the housing but leaving sufficient access for communication between the actuator and the valve control line.

10. The apparatus as claimed in any one of claims 1 and 6 further comprising a plurality of bucket support lines, each extending from one of the first end or second end of the spreader member to an attachment point on the bucket.

11. The apparatus as claimed in claim 10 further comprising an orientation line extending between the cargo ring and one of the first end or second end of the spreader member and operable to orient the spreader member to be perpendicular to the cargo ring.

12. The apparatus as claimed in claim 11 wherein the housing defines a compartment having an open end and further includes a mounting plate removably received in the compartment, and the actuator is mounted onto the mounting plate.

13. The apparatus as claimed in claim 12 wherein the housing further includes a cover along a lower edge of the mounting plate that is configured to substantially close the open end in the housing when the mounting plate is received within the compartment of the housing but leaving sufficient access for communication between the actuator and the valve control line.
